(19) United States
(12) Patent Application Publication
(10) Pub. No.: US 2014/0207606 A1
(43) Pub. Date: Jul. 24, 2014

(54) PRODUCT DESIGN SYSTEM

(71) Applicant: Mark Simon Harrison, Bampton (GB)

(72) Inventor: Mark Simon Harrison, Bampton (GB)

(21) Appl. No.: 13/747,016

(22) Filed: Jan. 22, 2013

(51) Int. Cl. G06Q 30/06

(52) U.S. Cl. CPC G06Q 30/0643
USPC 705/26.5

(57) ABSTRACT

A product design system is disclosed, the system comprising a user input device, a display device, and a product database containing product template files, each product template file containing a representation of a product and a dimension of the product. The system includes a product selection module for selecting a product template file from the product database based on user input from the user input device. An in-store display module is also provided for displaying the representation of the product together with a representation of a merchandise display unit, wherein the in-store display module displays the product and the merchandise display unit at a relative size determined by the dimension of the product contained in the selected product template file and a stored dimension of the merchandise display unit.

### FIELD OF THE INVENTION

The invention relates to a product design system for designing a range of products. The invention also relates to a method and program for designing a range of products.

### BACKGROUND

Known product design systems allow a user to design a product using preset templates stored in the system. Colors and graphics stored in the system may be applied to the basic product template by the user to design a final decorated object. For example, a template of a bag may be stored in the system, which includes areas of the outer surface of the bag to which colors and graphics can be applied. The user selects colors and graphics from a range available within the system and applies them to selected areas on the bag.

A decorated product design created by the user can be stored in the system and sent to a manufacturer. The manufacturer will then produce the product according to the stored user-created product design and ship the finished product to the user.

In this way, prior art product design systems allow users, who may be individuals or businesses, to customise their own products based on preset choices of product templates and graphics. However, problems exist with prior art systems as it can be difficult for a retailer or consumers to visualise how the customized product will look at the point of sale, particularly when a whole range of products is designed and then merchandised together. For retailers this can result in unattractive product displays and consequently reduced sales. For market research companies this can result in poor consumer feedback.

### SUMMARY OF THE INVENTION

In an embodiment, a product design system comprises: a user input device; a display device; a product database comprising product template files, each product template file comprising a representation of a product and a dimension of the product; a product selection module for selecting a product template file from the product database based on user input from the user input device; and an in-store display module for displaying the representation of the product together with a representation of a merchandise display unit, wherein the in-store display module displays the product and the merchandise display unit at a relative size determined by the dimension of the product contained in the selected product template file and a stored dimension of the merchandise display unit.

By displaying a view of the designed product on a virtual shelf or other virtual merchandise display unit at the correct relative size, embodiments allow the user to visualize accurately a display of the product as it would be merchandised in an actual shop. The user will be able to determine at the design stage whether the product is too large for the shelf, how many products can be displayed on a single shelf or other display unit, which other products the designed product should preferably be displayed with, and where the designed product should preferably be located in the display unit. Since the sizes of designed products are pre-loaded into the design system, no extra work is required by the user in order to provide the merchandise visualization.

In another embodiment, a product design system comprises: a user input device; a display device; a product database comprising product template files, packaging template files and graphics files, each product template file comprising a representation of a product and a dimension of the product, each packaging template file comprising a representation of packaging and a dimension of the packaging, and each graphics file containing a graphical image; a product selection module for selecting a product template file and a packaging template file from the product database based on user input from the user input device; a product design module for: displaying the representation of the product in the selected product template file and the representation of the packaging in the selected packaging template file; selecting an area of the representation of the product or an area of the representation of the packaging based on user input from the user input device; selecting a graphics file from the product database based on user input from the user input device; applying the graphical image in the selected graphics file to the selected area; and combining the representation of the product and the representation of the packaging to display a representation of the product in the packaging having the selected graphical image applied to the selected area, based on user input from the user input device.

This embodiment allows a user to design the packaging together with the product, which in turn allows the user to visualize how the product will look packaged in-store more easily. By displaying the product in the packaging during the design process, the embodiment makes it easier for a user to design packaging that is aesthetically appealing when combined with the associated product.

In another embodiment, a method for designing a product using a system including a user input device, a display device and a product database comprises: storing a representation of a product and a dimension of the product in a product template file in the product database; storing a representation of a merchandise display unit and a dimension of the merchandise display unit; selecting the product template file from the product database based on user input from the user input device; displaying the representation of the product in the selected product template file together with the representation of the merchandise display unit, wherein the product and the merchandise display unit are displayed at a relative size determined by the stored dimension of the product and the stored dimension of the merchandise display unit.

In another embodiment, a method for manufacturing a product comprises: performing the method for designing a product as described above; and manufacturing the product with the selected graphical image applied thereto based on user input from the user input device.

In another embodiment, a method for designing a product using a system including a user input device, a display device and a product database comprises: storing product template files, packaging template files and graphics files in the product database, each product template file comprising a representation of a product and a dimension of the product, each packaging template file comprising a representation of packaging and a dimension of the packaging, and each graphics file comprising a graphical image; selecting a product template file and a packaging template file from the product database based on user input from the user input device; displaying the representation of the product in the selected product template file and the representation of the packaging in the selected packaging template file; selecting an area of the representation of the product or an area of the representation of the packaging based on user input from the user input device; selecting a graphics file from the product database based on user input from the user input device; applying the graphical image in the selected graphics file to the selected area; and combining the representation of the product and the representation of the packaging to display a representation of the product in the packaging having the selected graphical image applied to the selected area, based on user input from the user input device.

In another embodiment, a method for designing a product using a system including a user input device, a display device and a product database comprises: storing product template files and packaging template files in the product database, each product template file comprising a representation of a product and a dimension of the product and each packaging template file comprising a representation of packaging and a dimension of the packaging; storing color data defining a plurality of colors; selecting a product template file and a packaging template file from the product database based on user input from the user input device; displaying the representation of the product in the selected product template file and the representation of the packaging in the selected packaging template file; selecting an area of the representation of the product or an area of the representation of the packaging based on user input from the user input device; selecting one of the plurality of colors based on user input from the user input device; applying the selected color to the selected area; and combining the representation of the product and the representation of the packaging to display a representation of the product in the packaging having the selected color applied to the selected area, based on user input from the user input device.

In another embodiment, a computer program product which, when run on a computer, causes the computer to perform one of the methods described above.

In another embodiment, a recording medium contains the computer program product described above.

### BRIEF DESCRIPTION OF THE DRAWINGS

Embodiments will now be described by way of further example only and with reference to the accompanying drawings, in which:

FIG. 1 is a schematic diagram showing the main components of a product design system according to an embodiment.

FIG. 2 illustrates a representation of a product displayed by a product design module in an embodiment.

FIG. 3 illustrates a representation of a product and a representation of packaging for the product displayed by a product design module in an embodiment.

FIG. 4 illustrates a combined representation of a product and packaging for the product displayed by a product design module in an embodiment.

FIG. 5 shows a representation of designed products on a virtual shelf, which is displayed by an in-store display module in an embodiment.

FIG. 6 shows a virtual gondola view, which is displayed by an in-store display module in an embodiment.

FIG. 7 shows a virtual aisle view, which is displayed by an in-store display module in an embodiment.

FIG. 8 shows a computer system in which an embodiment can be implemented.

### DETAILED DESCRIPTION

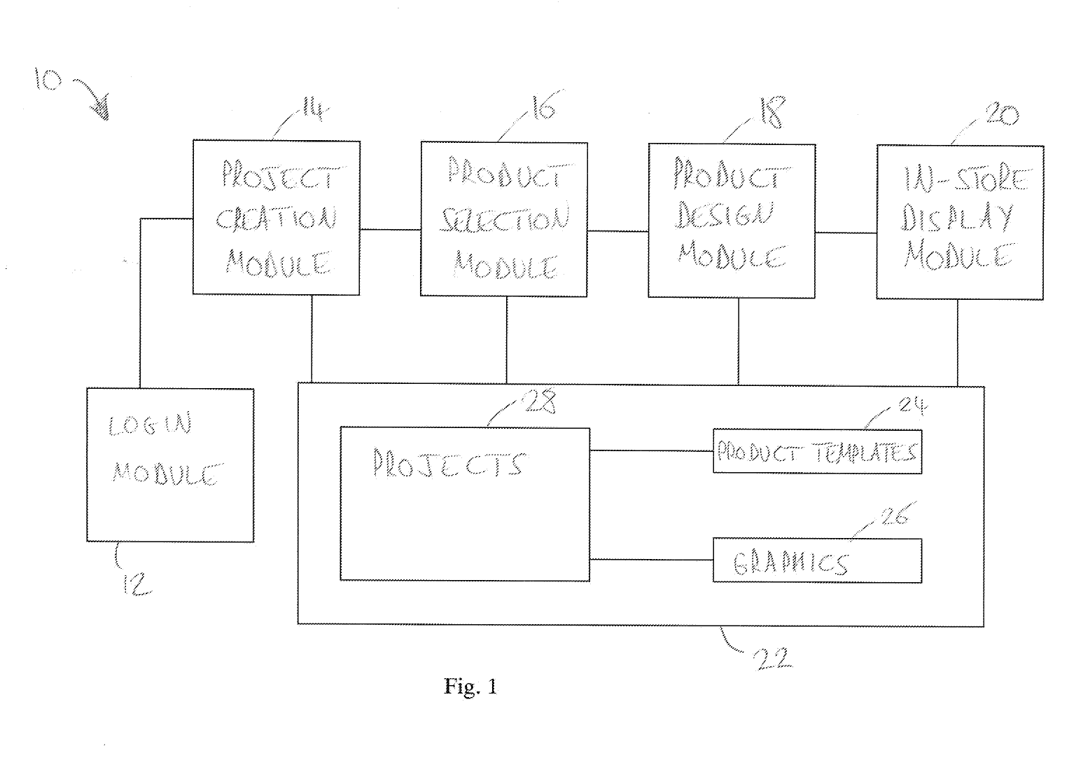

The design system 10 of an embodiment is illustrated in FIG. 1. The system comprises a product database 22 containing product template files 24, each including information on a product template, and graphics files 26, each including one or more graphical images that can be applied to the product templates. The product template files and graphics files are uploaded to the product database 22 by a product data provider, which may be the supplier of the design system or a third party. Each product template file includes a graphical representation of the product and information defining at least one dimension of the product. Color data indicating a range of colors may also be stored in the design system 10.

The system also includes a display device and one or more user input devices such as a mouse and keyboard (not shown), which allow a user to operate a user interface. The user interface can present selectable areas such as buttons to the user on the display device in a known fashion. The user can then select an area of the screen of the display device by moving a mouse cursor over the desired area and operating a mouse button, as is conventional. However, the details of the user interface are not essential to the invention and any other known type of user interface such as a touch or gesture-driven interface can be used.

As shown in FIG. 1, the system 10 comprises a login module 12, a project creation module 14, a product selection module 16, a product design module 18 and an in-store display module 20. The user interface allows the user to interact with the modules of the system as described below. The login module 12 requests a login ID and password from a user, and compares the login ID and password provided by the user to a login database of valid login details. If the login ID and password match a set of login details stored in the login database then the login module 12 logs the user in under the appropriate login ID. Otherwise, the login module 12 denies the user access to the system.

There are generally at least two distinct user groups for the system 10. The first group are template designers, who design product templates and upload them to the system in the form of product template files. The second group are product designers, who do not design their own templates but design products based on the uploaded templates. The following discussion relates primarily to the system as used by product designers.

The project creation module 14 operates after the user is logged in to the system and allows the user to either select an existing stored project or create a new project. A project comprises a range of products, which may be at various stages of the design process, and has an associated name. For example, a project may have the name “back to school” and contain a range of school-related products. Projects 28 are stored by the system in the product database 22. The project creation module 14 displays a list of existing projects to the user for selection.

If the user selects an existing project then the range of products forming part of the selected project is displayed to the user on a project home screen. On the other hand, if the user opts to create a new project then the project creation module 14 prompts the user to enter a name for the project. The system can also prompt the user to enter other information about the project to be stored in the product database 22, for example a description and the name of the project manager. Once the required information has been entered, the system displays the home screen for the new project, which at this stage will not contain any products.

From the project home screen, the user has the option to begin a product selection process. For example, the home screen may include an “add item” button to be pressed by the user. If the user activates this process then the product selection module 16 displays a list of product templates 24 that are stored in the product database 22 to the user. These products have previously been uploaded to the system 10 by template designers. The user can select a template on which to base a product design from the list. For example, the product templates may include a range of products for schoolchildren such as pencil cases, stationery sets and lunch boxes.

Once the user has selected a product template 24, the product selection module 16 adds the template to the current project 28. The product corresponding to the template is then displayed to the user on the project home screen.

From the project home screen, the user can select one of the product templates that has been added to the project. The user then has the option to edit the product. When the user selects this option, the product design module 18 is activated.

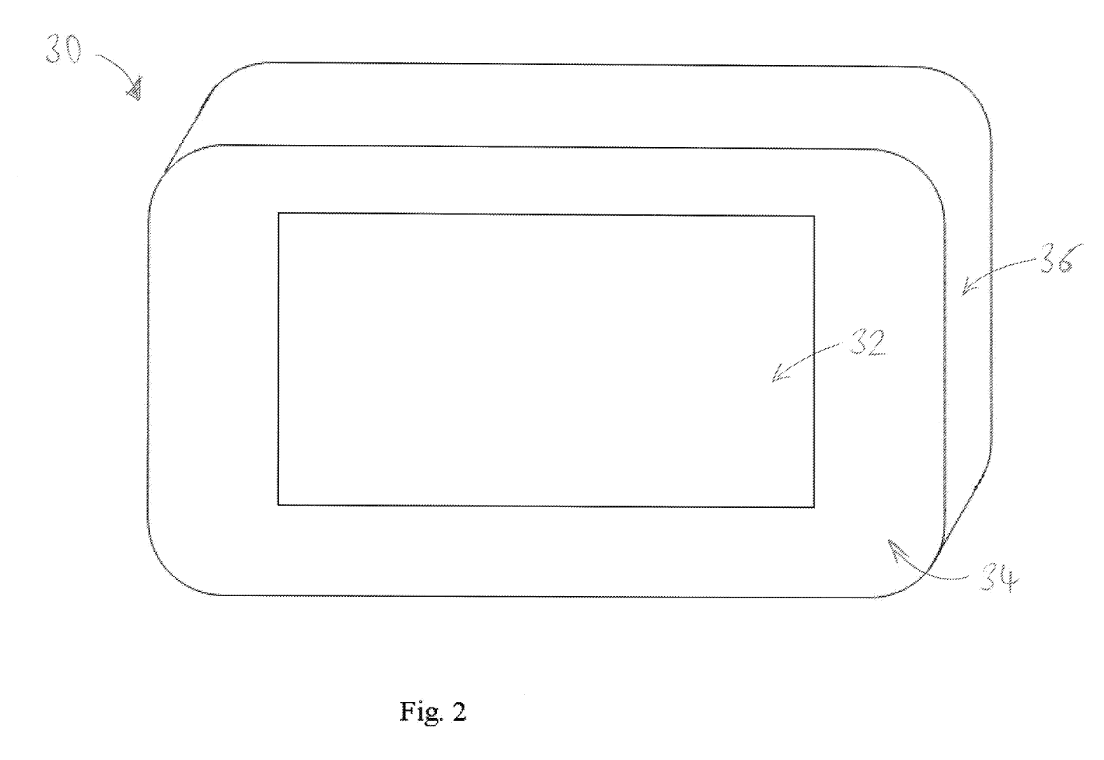

The product design module 18 displays a representation of the product, which can be larger than the representation shown on the project home screen. An example of a representation of a product is shown in FIG. 2, the product 30 being a lunch box. The representation may be 2D or 3D and can be static or rotatable based on input from a user. The product template is divided into distinct areas 32, 34 and 36, each of which is displayed by the product design module 18. The areas are pre-determined by the template designer who designed the product template and are stored in the product template file. In this case, the areas are a front centre panel 32 of the lunch box, an outer front section 34 and a side panel 36. The product design module 18 allows the user to select one or more of these areas on the displayed representation of the product.

Two or more of the areas 32, 34 and 36 in the product template can be linked so that selecting one of those areas also selects the linked area(s). This allows the same graphic or color to be applied to all of the linked areas together. The linking is determined in advance by the template designer and is stored in the product template file. This is particularly useful when a 2D representation shows a continuous surface on the actual product as separate areas, which should be linked.

Once the user has selected one or more areas of the product, the user has the option to add graphics and/or one of the colors indicated by the color data stored in the design system 10 to the area(s). When the user selects this option, the product design module 18 presents the user with a list of available graphics 26. The graphics are stored in the product database 22 and may include artwork, logos and patterns. There is no limitation on the type of graphics that can be stored, and the graphics can also include plain colors. When the user selects a graphic from the list or a color, the product design module 18 returns to displaying the representation of the product and the selected graphic is displayed on the area(s) of the product previously selected.

The user can repeat the above process for each of the areas of the product displayed by the product design module 18, until all of the areas of the product have an associated graphic and/or color overlaid on them. At this point, the product design is complete and the user can return to the project home screen. The designed product is displayed by the system on the project home screen with all of the added graphics and/or colors shown.

The product design module 18 can also allow the user to select and design packaging for a product. The packaging can form part of the product template file stored in the product database 22 or can be stored separately as a packaging template file. The packaging template file includes a representation of the packaging and at least one dimension of the packaging. The dimension of the packaging can be an absolute dimension or can be defined relative to a dimension of the product. The size of the packaging relative to the size of the product must be known to the system so that representations of the product and the packaging can be shown at the appropriate scales.

The packaging for the product can be displayed together with the product itself in a single representation displayed by the product design module 18. The user can select areas of that representation and apply graphics and/or colors to those areas as described above.

Alternatively, the product design module 18 can display a representation of the packaging separately, without the product itself. In this embodiment, the user can design the packaging alone in the same way as designing a product as described above. The user can select areas of the representation of the packaging displayed by the product design module 18 and select graphics from the product database 22 to be applied to those areas. The user can design the product associated with the packaging as described above.

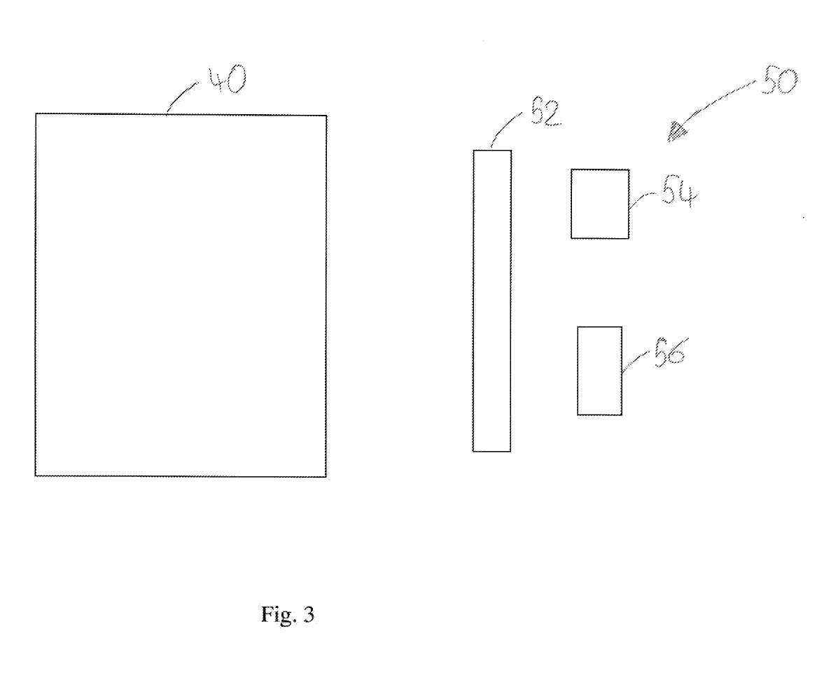

The product design module 18 can display the product alongside the packaging on the screen and allow the user to design both simultaneously. This arrangement is shown in FIG. 3, where a representation of packaging 40 for a stationery set 50 is displayed alongside the stationery set contents 50. In this example, graphics can be applied individually to the packaging 40 and a ruler 52, a pencil sharpener 54 and an eraser 56 making up the stationery set.

In any of the above packaging design arrangements, the product design module 18 can also allow the user to enter text to be applied to the packaging. The user first selects an area of the displayed representation of the packaging and opts to enter text. Selection of this option by the user activates a text editor, using which the user can enter text to be applied to the selected area of the packaging. The text can be a description of the product or the contents of the packaging for example. Once the text has been entered, the user can opt to apply the text to the packaging. The text is then displayed by the product design module 18 on the selected area of the representation of the packaging.

Although the text entry option described above is most useful for designing packaging, it can also be applied to designing the product itself in some embodiments of the invention. The product design module 18 can allow the user to enter text to be applied to a selected area of the product in the same way as described above.

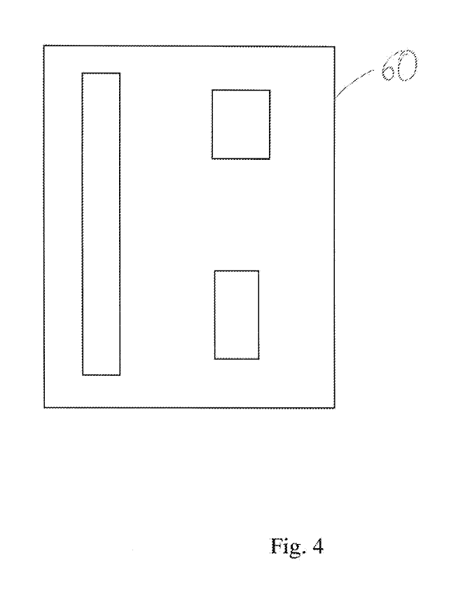

On selection of an associated control by the user via the user input device, the product design module 18 will combine the representations of the product and the packaging at their current stage of design, i.e. including any graphics, colors or text that have been added, into a single image. An example of such a single image is shown in FIG. 4. The representations of the packaging 40 and the stationery set 50 of FIG. 3 are combined into a single image 60, which shows the product and packaging as it would be displayed in-store.

The single image 60 illustrates how the designed packaging and product will look when the product is packaged. By selecting another control, the user can instruct the system to separate the product and packaging again. The product design module 18 then displays the product and the packaging alongside each other as before and allows the user to continue the design process.

A script for combining the representations of the product 50 and the packaging 40 into a single image 60 can be stored in the product database 22 in association with the corresponding product template. Alternatively, the product design module 18 can have a script containing standard rules for combining the two representations.

Projects and the designed or partially designed products within them can be saved by the user at any time by selecting a corresponding button. The system can also automatically save the current project and designed products, either at regular intervals or whenever a new product, graphic or color is added. The projects 28 and the associated products are stored in the product database 22 and are retrieved by the system the next time the user logs in to the system, to be displayed to the user by the project creation module 14 as described above.

The in-store display module 20 allows the user to see how the designed product 60 would look on a shelf in-store. On the project home screen, the user can select a designed or partially designed product forming part of the project and then select an option to add the selected product to the shelf display.

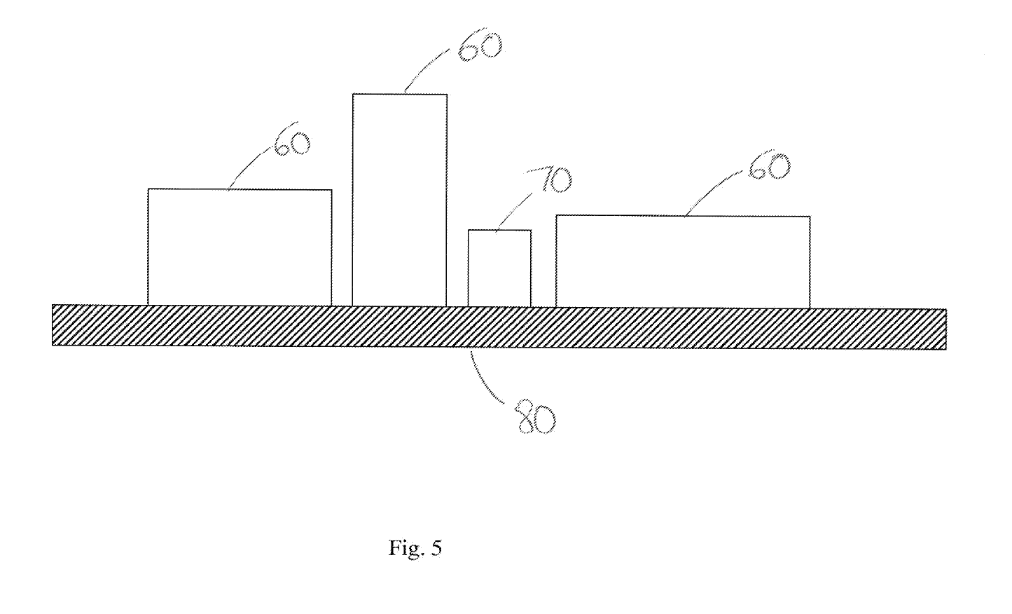

The user can activate the in-store display module 20 from the project home screen, for example by selecting an associated tab. On activation, the in-store display module 20 displays a representation of all of the products that have previously been added to the shelf display as described above. An example of such a shelf display representation is shown in FIG. 5.

The products 60 are shown as being arranged on a virtual shelf 80, which corresponds in size and appearance to a predetermined shelf size. Optionally, the size and appearance of the virtual shelf can be adjustable by the user. The user can also choose a number of virtual shelves to be displayed rather than a single shelf. The representation of the virtual shelf can be determined by a virtual shelf template file stored in the product database 22. The virtual shelf template includes a graphical representation of the shelf and information defining at least one dimension of the shelf.

The in-store display module 20 displays the products 60 at the correct sizes relative to each other and to the virtual shelf 80. The displayed sizes of the products are determined by the information on at least one dimension of the product stored in the product template for each product. As a result, the user can see at a glance how the various products within the current project will look when arranged on a shelf next to one another. The accurate sizes also allow the user to determine how much shelf space will be required to display the desired number of products.

In one embodiment, the user can select standard products 70 other than those that have been designed by the system to be displayed by the in-store display module 20. For example, on activation of a corresponding button by the user, the in-store display module 20 can present a list of stored standard products 70 to the user and the user can select one to be displayed. Representations of the standard products 70 and at least one dimension of each standard product can be stored in the product database 22 as standard product template files.

The in-store display module 20 then displays on the virtual shelf the selected standard product together with the selected designed products forming part of the current project. This feature allows the user to determine how the sizes and appearance of the designed products compare to existing products. The feature also makes it easier for the user to determine which standard products the designed products should ideally be placed next to in-store.

Although the in-store display module 20 has been described as displaying a virtual shelf in the embodiment above, all embodiments are not limited to this. The in-store display module 20 can display a representation of any known type of in-store display unit together with the designed and standard products 60, 70. For example, the in-store display module 20 could display a representation of the products in a display cabinet or clothing hanging from hooks in alternative embodiments.

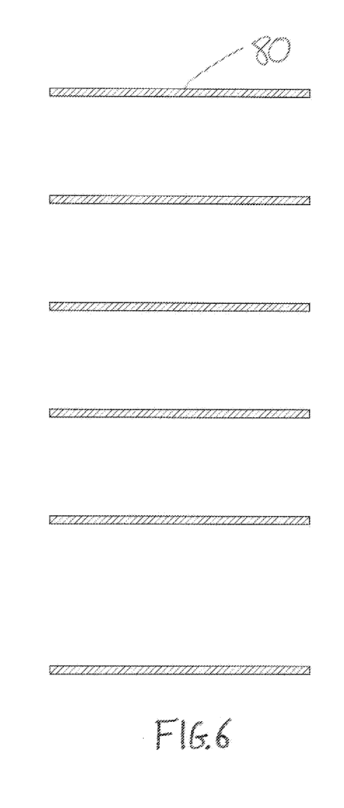

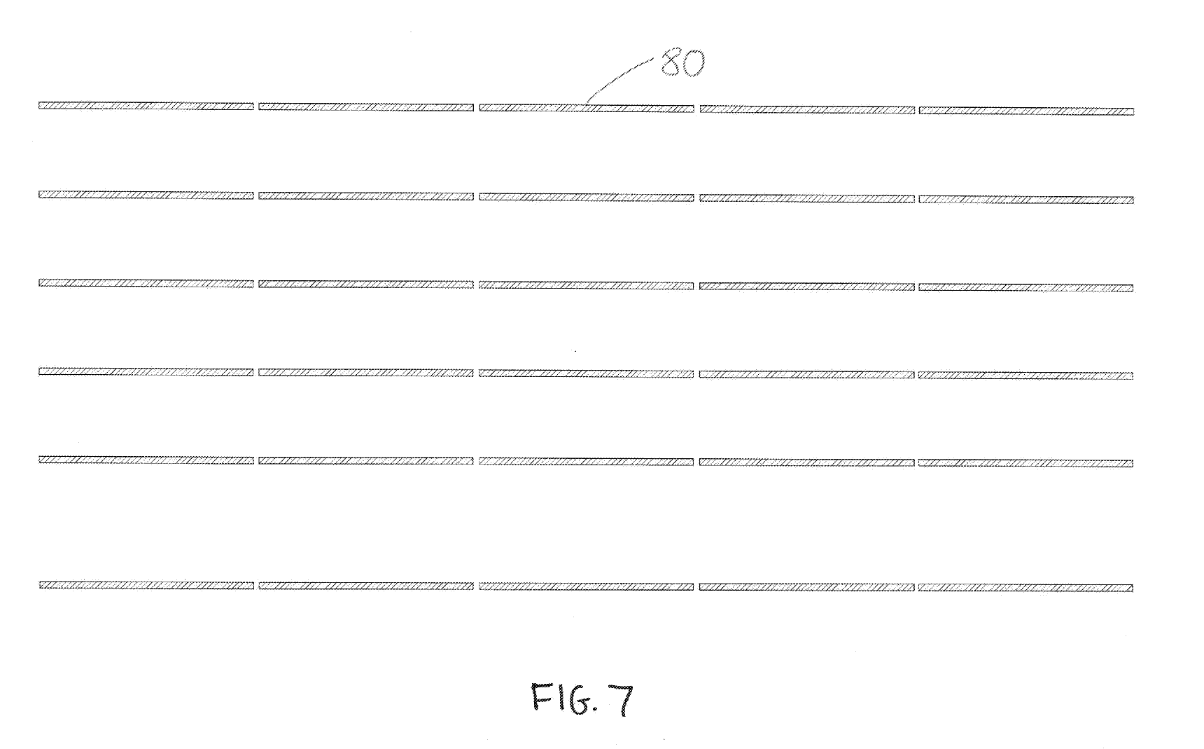

The in-store display module 20 can also display a plurality of shelves arranged in a vertical stack to form a representation of a gondola, as shown in FIG. 6. Designed products can be placed on any of the virtual shelves making up the gondola. Furthermore, the in-store display module 20 can display multiple gondolas arranged in a horizontal array to form a representation of a shop aisle, as shown in FIG. 7. Designed products can be placed on any of the virtual shelves making up each gondola of the virtual aisle.

The in-store display module 20 allows a user to copy and paste a product that has already been placed on a virtual shelf, gondola or aisle so that multiple instances of the same product can easily be displayed next to each other. Representations of products can also be dragged from one location on a virtual display unit to another using the in-store display module 20. The in-store display module 20 can provide settings to allow the user to alter properties of the virtual display units such as shelf width and shelf height, which alter the size of the virtual shelf relative to the products.

The system also allows the user to store financial information such as product costs and/or selling prices in association with the designed products in the product database. This financial information can be combined with other data such as numbers of stores and rates of sale to analyse the potential financial performance of a given range of designed products. The relative sizing of the designed products on a display unit provided by the system of the invention assists in this analysis because it can be determined how many products can be stocked on a given display unit in a given store at any one time.

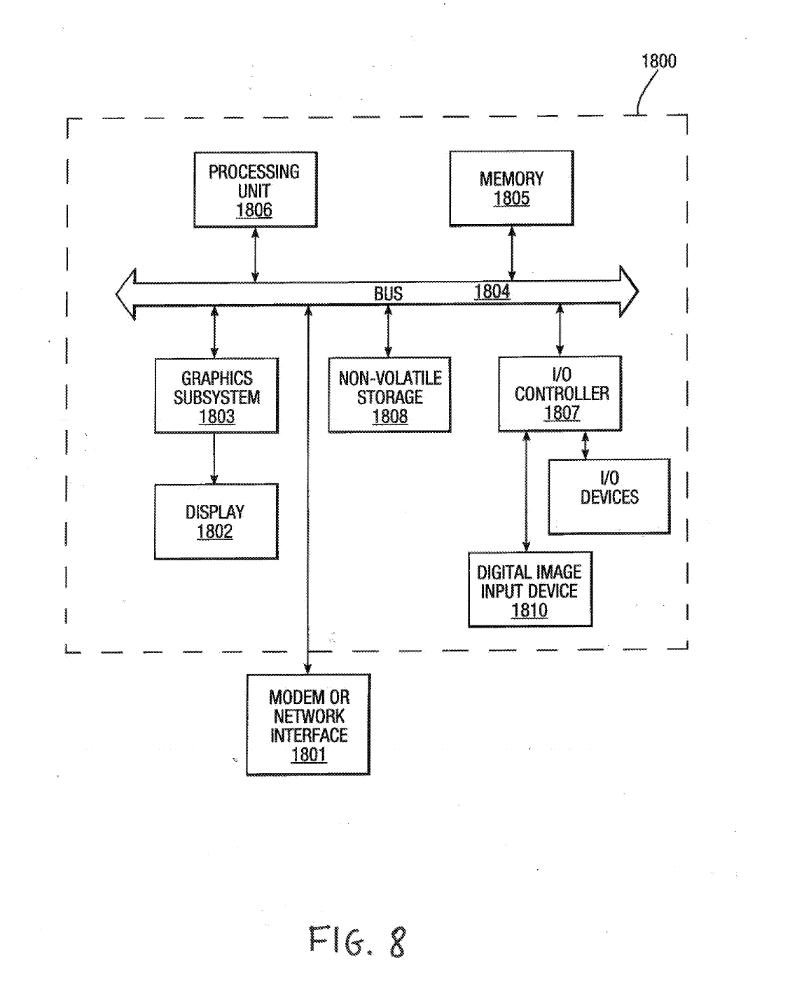

FIG. 8 illustrates an exemplary embodiment of a computer system 1800 in which embodiments of the system and method can be realized.

The computer system 1800 can interface to external systems through a fixed wire or wireless connection or any other network interface 1801 such as analog or ISDN modems, cable modems (ADSL/DSL), Ethernet or fiber optic interfaces, cellular or HSDS services and satellite transmission interfaces. As shown in FIG. 8, the computer system 1800 includes a processing unit 1806, which can be a conventional microprocessor, such as an Intel Core microprocessor or an ARM Cortex microprocessor, which are known to one of ordinary skill in the computer arts.

System memory 1805 is coupled to the processing unit 1806 by a system bus 1804. System memory 1805 can be a DRAM, RAM, static RAM (SRAM) or any combination thereof. Bus 1804 couples processing unit 1806 to system memory 1805, to non-volatile storage 1808, to graphics subsystem 1803 and to input/output (I/O) controller 1807. Graphics subsystem 1803 controls a display device 1802, for example a liquid crystal display, which can be part of the graphics subsystem 1803. The display device 1802 corresponds to the display device discussed above. The I/O devices can include one or more of a keyboard, tablet, stylus, disk drives, printers, a mouse, a touch screen or other gesture driven interface and the like as known to one of ordinary skill in the computer art. The I/O devices correspond to the user input devices discussed above.

A digital image input device 1810 can be a scanner or a digital camera, which is coupled to I/O controller 1807. The non-volatile storage 1808 can be a magnetic hard disk, a flash memory or another form of storage for large amounts of data. Some of this data is often written by a direct memory access process into the system memory 1805 during execution of the software in the computer system 1800. The non-volatile storage 1808 may contain the product database 22.

Embodiments of the system can also include a manufacturing unit or plant, which is communicably connected to the product design system 10. Once a product has been designed using the product design system, a user can instruct the system to manufacture the product via the user input device. On receiving this instruction from the user, the product design system 10 sends information identifying the product template, a packaging template if included, and which graphics have been applied to which areas on the designed product to the manufacturing unit. In other words, the product design system 10 automatically instructs the manufacturing unit to manufacture the designed product including the graphics added by the user.

Using the system, a user can design the look of a range of products based on stored templates and compare the products side-by-side. This avoids the need to hire an expensive external designer in many cases. The user can also accurately visualize the relative sizes of the products and their sizes relative to a merchandise display unit. Once the range has been approved by the user, the system can be used to download data representing the range of products to enable internal review, briefing factories for orders, analyzing range profitability and/or presenting the range to consumers for their feedback.

The foregoing description has been given by way of example only and it will be appreciated by a person skilled in the art that modifications can be made without departing from the scope of the present invention.

What is claimed is:

1. A product design system comprising:
a user input device;
a display device;
a product database comprising product template files, each product template file comprising a representation of a product and a dimension of the product;
a product selection module for selecting a product template file from the product database based on user input from the user input device; and
an in-store display module for displaying the representation of the product together with a representation of a merchandise display unit, wherein the in-store display module displays the product and the merchandise display unit at a relative size determined by the dimension of the product contained in the selected product template file and a stored dimension of the merchandise display unit.

2. A product design system according to claim 1, wherein the in-store display module sets the stored dimension of the merchandise display unit based on user input from the user input device.

3. A product design system according to claim 1, wherein the merchandise display unit is one of a virtual shelf, a virtual gondola comprising a plurality of virtual shelves and a virtual aisle comprising a plurality of virtual gondolas.

4. A product design system according to claim 1, wherein the product database further comprises graphics files, each graphics file comprising a graphical image, the system further comprising:
a product design module for:
displaying the representation of the product in the selected product template file;
selecting an area of the representation of the product based on user input from the user input device;
selecting a graphics file from the product database based on user input from the user input device; and
applying the graphical image in the selected graphics file to the selected area;
wherein the in-store display module displays the representation of the product with the selected graphical image applied to it with the representation of the merchandise display unit.

5. A product design system according to claim 1, wherein the system comprises stored color data defining a plurality of colors, the system further comprising:
a product design module for:
displaying the representation of the product in the selected product template file;
selecting an area of the representation of the product based on user input from the user input device;
selecting one of the plurality of colors based on user input from the user input device; and
applying the selected color to the selected area;
wherein the in-store display module displays the representation of the product with the selected color applied thereto with the representation of the merchandise display unit.

6. A product design and manufacturing system comprising:
a product design system according to claim 4; and
a manufacturing unit for manufacturing the product with the selected graphical image applied to it based on user input from the user input device.

7. A product design system according to claim 4,
wherein the product database includes standard product template files, each standard product template file comprising a representation of a standard product and a dimension of the standard product, and
wherein the in-store display module selects a standard product file based on user input from the user input device and displays the representation of the standard product in the selected standard product template file together with the representation of the product with the selected graphical image applied to it and the representation of the merchandise display unit.

8. A product design system according to claim 4,
wherein the product database further includes packaging template files, each packaging template file comprising a representation of packaging and a dimension of the packaging,
wherein the product design module is for:
displaying the representation of the product in the selected product template file and the representation of the packaging in the selected packaging template file;
selecting an area of the representation of the product or an area of the representation of the packaging based on user input from the user input device;
selecting a graphics file from the product database based on user input from the user input device;
applying the graphical image in the selected graphics file to the selected area; and
combining the representation of the product and the representation of the packaging to display a representation of the product in the packaging having the selected graphical image applied to the selected area, based on user input from the user input device; and
wherein the in-store display module displays the combined representation of the product and the packaging as the representation of the product.

9. A product design system according to claim 4,
wherein the selected product template file further includes a representation of packaging and a dimension of the packaging,
wherein the product design module is for:
displaying the representation of the product and the representation of the packaging in the selected product template file;
selecting an area of the representation of the product or an area of the representation of the packaging based on user input from the user input device;
selecting a graphics file from the product database based on user input from the user input device;
applying the graphical image in the selected graphics file to the selected area; and
combining the representation of the product and the representation of the packaging to display a representation of the product in the packaging having the selected graphical image applied to the selected area, based on user input from the user input device; and
wherein the in-store display module displays the combined representation of the product and the packaging as the representation of the product.

10. A product design system according to claim 4, wherein the product template file comprises a link between two or more areas of the representation of the product, so that selecting one of the linked areas also selects the other linked area(s).

11. A product design system comprising:
a user input device;
a display device;
a product database comprising product template files, packaging template files and graphics files, each product template file comprising a representation of a product and a dimension of the product, each packaging template file comprising a representation of packaging and a dimension of the packaging, and each graphics file containing a graphical image;
a product selection module for selecting a product template file and a packaging template file from the product database based on user input from the user input device;
a product design module for:
displaying the representation of the product in the selected product template file and the representation of the packaging in the selected packaging template file;
selecting an area of the representation of the product or an area of the representation of the packaging based on user input from the user input device;
selecting a graphics file from the product database based on user input from the user input device;
applying the graphical image in the selected graphics file to the selected area; and
combining the representation of the product and the representation of the packaging to display a representation of the product in the packaging having the selected graphical image applied to the selected area, based on user input from the user input device.

12. A method for designing a product using a system including a user input device, a display device and a product database, the method comprising:
storing a representation of a product and a dimension of the product in a product template file in the product database;
storing a representation of a merchandise display unit and a dimension of the merchandise display unit;
selecting the product template file from the product database based on user input from the user input device; and
displaying the representation of the product in the selected product template file together with the representation of the merchandise display unit, wherein the product and the merchandise display unit are displayed at a relative size determined by the stored dimension of the product and the stored dimension of the merchandise display unit.

13. A method for designing a product according to claim 12, further comprising:
storing graphics files in the product database, each graphics file comprising a graphical image;
displaying the representation of the product in the selected product template file;
selecting an area of the representation of the product based on user input from the user input device;
selecting a graphics file from the product database based on user input from the user input device;
applying the graphical image in the selected graphics file to the selected area; and
displaying the representation of the product with the selected graphical image applied to it together with the representation of the merchandise display unit.

14. A method for designing a product according to claim 12, further comprising:
storing color data defining a plurality of colors;
displaying the representation of the product in the selected product template file;
selecting an area of the representation of the product based on user input from the user input device;
selecting one of the plurality of colors based on user input from the user input device;
applying the selected color to the selected area; and
displaying the representation of the product with the selected color applied thereto together with the representation of the merchandise display unit.

15. A method for manufacturing a product, comprising:
performing the method for designing a product according to claim 13; and
manufacturing the product with the selected graphical image applied thereto based on user input from the user input device.

16. A method for designing a product according to claim 13, further comprising:
storing standard product template files in the product database, each standard product template file comprising a representation of a standard product and a dimension of the standard product;
selecting a standard product template file based on user input from the user input device; and
displaying the representation of the standard product in the selected standard product template file together with the representation of the product with the selected graphical image applied thereto and the representation of the merchandise display unit,
wherein the standard product and the merchandise display unit are displayed at a relative size determined by the stored dimension of the standard product and the stored dimension of the merchandise display unit.

17. A method for designing a product according to claim 13, further comprising:
storing packaging template files in the product database, each packaging template file containing a representation of packaging and a dimension of the packaging;
selecting a packaging template file based on user input from the user input device;
displaying the representation of the product in the selected product template file and the representation of the packaging in the selected packaging template file;
selecting an area of the representation of the product or an area of the representation of the packaging based on user input from the user input device;
selecting a graphics file from the product database based on user input from the user input device;
applying the graphical image in the selected graphics file to the selected area;
combining the representation of the product and the representation of the packaging to display a representation of the product in the packaging having the selected graphical image applied to the selected area, based on user input from the user input device; and
displaying the combined representation of the product and the packaging as the representation of the product.

18. A method for designing a product according to claim 13, wherein the selected product template file further includes a representation of packaging and a dimension of the packaging, the method further comprising:
displaying the representation of the product and the representation of the packaging in the selected product template file;
selecting an area of the representation of the product or an area of the representation of the packaging based on user input from the user input device;
selecting a graphics file from the product database based on user input from the user input device;
applying the graphical image in the selected graphics file to the selected area;
combining the representation of the product and the representation of the packaging to display a representation of the product in the packaging having the selected graphical image applied to the selected area, based on user input from the user input device; and
displaying the combined representation of the product and the packaging as the representation of the product.

19. A method for designing a product using a system including a user input device, a display device and a product database, the method comprising:
storing product template files, packaging template files and graphics files in the product database, each product template file comprising a representation of a product and a dimension of the product, each packaging template file comprising a representation of packaging and a dimension of the packaging, and each graphics file comprising a graphical image;
selecting a product template file and a packaging template file from the product database based on user input from the user input device;
displaying the representation of the product in the selected product template file and the representation of the packaging in the selected packaging template file;
selecting an area of the representation of the product or an area of the representation of the packaging based on user input from the user input device;
selecting a graphics file from the product database based on user input from the user input device;
applying the graphical image in the selected graphics file to the selected area; and
combining the representation of the product and the representation of the packaging to display a representation of the product in the packaging having the selected graphical image applied to the selected area, based on user input from the user input device.

20. A method for designing a product using a system including a user input device, a display device and a product database, the method comprising:
storing product template files and packaging template files in the product database, each product template file comprising a representation of a product and a dimension of the product and each packaging template file comprising a representation of packaging and a dimension of the packaging;
storing color data defining a plurality of colors;
selecting a product template file and a packaging template file from the product database based on user input from the user input device;
displaying the representation of the product in the selected product template file and the representation of the packaging in the selected packaging template file;
selecting an area of the representation of the product or an area of the representation of the packaging based on user input from the user input device;
selecting one of the plurality of colors based on user input from the user input device;
applying the selected color to the selected area; and
combining the representation of the product and the representation of the packaging to display a representation of the product in the packaging having the selected color applied to the selected area, based on user input from the user input device.

21. A computer program product which, when run on a computer, causes the computer to perform the method according to claim 12.

22. A computer program product which, when run on a computer, causes the computer to perform the method according to claim 19.

23. A recording medium containing the computer program product according to claim 21.

24. A recording medium containing the computer program product according to claim 22.
